(19) United States
(12) Patent Application Publication
(10) Pub. No.: US 2012/0235497 A1
(43) Pub. Date: Sep. 20, 2012

(54) METHOD OF CONTROLLING A BATTERY, COMPUTER READABLE RECORDING MEDIUM, ELECTRICAL POWER GENERATION SYSTEM AND DEVICE CONTROLLING A BATTERY

(75) Inventors: Souichi SAKAI, Moriguchi-shi (JP); Ken Yamada, Moriguchi-shi (JP)

(73) Assignee: SANYO Electric Co., Ltd., Moriguchi-shi (JP)

(21) Appl. No.: 13/425,108

(22) Filed: Mar. 20, 2012

Related U.S. Application Data
(63) Continuation of application No. PCT/JP2011/051687, filed on Jan. 28, 2011.

(30) Foreign Application Priority Data
Jan. 28, 2010 (JP) 2010-016524

(51) Int. Cl. H02J 1/00

(52) U.S. Cl. 307/80

(57) ABSTRACT

This method of controlling a battery storing electric power generated by a power generator generating electric power using renewable energy comprising, detecting a power output data at plural points in time during a specified period, the power output data being amounts of electric power generated by the power generator, computing a target output value for supplying to an electric power transmission system based on an average value of the power output data detected at the plural points, and supplying to the electric power transmission system electric power corresponding to the target output value from at least one of the power generator and the battery, wherein the average value is determined so that different weights are applied to the power output data detected at the plural points in calculating the average value.

### CROSS REFERENCE TO RELATED APPLICATIONS

This application is a continuation of International Application No. PCT/JP2011/051687, filed Jan. 28, 2011, which claims priority from Japanese Patent Application No. 2010-016524, filed Jan. 28, 2010, the entire contents of which are incorporated herein by reference.

### FIELD OF INDUSTRIAL USE

The present invention relates to a method of controlling a battery, a computer readable recording medium, electrical power generation system and a device controlling a battery.

### PRIOR ART

In recent years, the number of instances where power generator (solar cells etc.) utilizing renewable energy such as wind power or sunlight are connected to consumers (e.g. consumer homes and factories) in receipt of a supply of alternating power from an electricity substation has increased. These types of power generator are connected to the power grid subordinated to the substation, and power generated by the generators is output to the power consuming devices side of the consumer location. Moreover, the superfluous electric power, which is not consumed by the power consuming devices in the consumer location, is output to the power grid. The flow of this power towards the power grid from the consumer location is termed “counter-current flow”, and the power output from the consumer to the electric grid is termed “counter-current power”.

In this situation the power suppliers such as the power companies and the like have a duty to ensure the stable supply of electric power and need to maintain the stability of the frequency and voltage of the overall power grid, including the counter-current power components. For example, the power supply companies maintain the stability of the frequency of the overall electric power grid by a plurality of methods in correspondence with the size of the fluctuation period. Specifically, in general, in respect of a load component with a variable period of over ten minutes, economic dispatching control (EDC) is performed to enable output sharing of the generated amount in the most economical manner. This EDC is controlled based on the daily load variation expectation, and it is difficult to respond to the increases and decreases in the load fluctuation from minute to minute and second to second (the components of the fluctuation period which are less than over ten minutes). In that instance, the power companies adjust the amount of power supplied to the power grid in correspondence with the minute fluctuations in the load, and perform plural controls in order to stabilize the frequency. Other than the EDC, these controls are called frequency controls, in particular, and the adjustments of the load variation components not enabled by the adjustments of the EDC are enabled by these frequency controls.

More specifically, for the components with a fluctuation period of not more than approximately 10 seconds, their absorption is enabled naturally by means of the endogenous control functions of the power grid itself. Moreover, for the components with a fluctuation period of about 10 seconds to the order of several minutes, they can be dealt with by the governor-free operation of the generators in each generating station. Furthermore, for the components with a fluctuation period of the order of several minutes to tens of minutes, they can be dealt-with by load frequency control (LFC). In this load frequency control, the frequency control is performed by the adjustment of the generated power output of the generating station for LFC by means of a control signal from the central power supply command station of the power supplier.

However, the output of power generators utilizing renewable energy may vary abruptly in correspondence with the weather and such like. This abrupt fluctuation in the power output of this type of power generator applies a gross adverse impact on the degree of stability of the frequency of the power grid they are connected to. This adverse impact becomes more pronounced as the number of consumers with generators using renewable energy increases. As a result, in the event that the number of consumers with electricity generators utilizing renewable energy increases even further henceforth, there will be a need arising for sustenance of the stability of the power grid by the control of the abrupt variation in the output of the generators.

In relation to that, there have been proposals, conventionally, to provide power generation systems with battery to enable the storage of electricity resulting from the power output generated by electricity generators, in addition to the generators utilizing renewable energy, in order to control the abrupt fluctuation in the power output of these types of generators. Such a power generation system was disclosed, for example, in Japanese laid-open patent publication No. 2001-5543.

In the Japanese laid-open published patent specification 2001-5543 described above, there is the disclosure of a power system provided with solar cells, and invertors which are connected to both the solar cells and the power grid, and a battery which is connected to a bus which is also connected to the invertor and the solar cells. In the Japanese laid-open published patent specification 2001-5543 described above, the power generated data values for past specific power supply period are divided by the number of periods to compute a moving average value (a target output value), and by performing charge and discharge of a battery to add or subtract the difference of the generated power output by the generated by the solar cell from the moving average value, in order that the output power to the power grid from the invertor matches that moving average value, smoothing control is performed to suppress the fluctuation in the power output in counter current flow to the power grid. By this means, the suppression of the adverse impact on the frequency of the power grid is enabled.

### PRIOR ART REFERENCES

Patent Reference #1: Japanese laid-open published patent specification 2001-5543.

### OUTLINE OF THE INVENTION

### Problems to be Solved by the Invention

However, in Japanese laid-open published patent specification 2001-5543, when the fluctuation in the actual generated power output is great, because the moving average value of taken from the average of the generated power output in specific periods does not fluctuate as widely as the fluctuation amount of the actual power output, there is a large divergence between the actual generated power output and the moving average value (target output value). In this situation, the amount of charging and discharging of the battery, which corresponds to the difference between the actual generated power output and the target output value, is great and as a result, this gives rise to the problem that the lifetime of the battery is shortened.

This invention was conceived of to resolve the type of problems described above, and one object of this invention is the provision of a power supply method, a computer readable recording medium and a power generation system which contrive to enable a longer lifetime for the battery while suppressing the effects on the power grid caused by the fluctuations in the output power of the power generator.

### SUMMARY OF THE INVENTION

In order to achieve the objectives described above, the method of controlling a battery storing electric power generated by a power generator generating electric power using renewable energy of the present invention, the method comprising, detecting a power output data at plural points in time during a specified period, the power output data being amounts of electric power generated by the power generator, computing a target output value for supplying to an electric power transmission system based on an average value of the power output data detected at the plural points, and supplying to the electric power transmission system electric power corresponding to the target output value from at least one of the power generator and the battery, wherein the average value is determined so that different weights are applied to the power output data detected at the plural points in calculating the average value.

The computer-readable recording medium which records a control programs for causing one or more computers to perform the steps of the present invention comprising, detecting a power output data at plural points in time during a specified period, the power output data being amounts of electric power generated by the power generator, computing an average value of the power output data detected at the plural points so that so that different weights are applied to the power output data detected at the plural points in calculating the average value, computing a target output value for supplying to an electric power transmission system based on the average value, and supplying to the electric power transmission system electric power corresponding to the target output value from at least one of the power generator and the battery.

The electric power generation system of the present invention, comprising, a power generator configured to generate electric power using renewable energy, a battery configured to store electric power generated by the power generator, a detector configured to acquire power output data at plural points in time during a specified perios, the power output data being the amount of electric power generated by the power generator, and a controller configured to compute an average value of the power output data detected at the plural points so that different weights are applied to the power output data detected at the plural points in calculating the average value, to compute a target output value for supplying to an electric power transmission system based on the average value, to supply to the electric power transmission system electric power corresponding to the target output value from at least one of the power generator and the battery.

### BENEFITS OF THE PRESENT INVENTION

By means of the present invention even when the actual power output fluctuates greatly, if the target output value is computed with different weighting applied to the generated power output data before and after fluctuations such that the target output value approximates the post fluctuation generated power output, the value of the target output value can be caused to better reflect the post-fluctuation power output value. By this means, suppression of a large difference between the target output value and the actual generated power output is enabled. As a result, because the amount of charge and discharge of the battery which is the difference between the actual generated power output and the target output value can be reduced, a contrivance at lengthening the lifetime of the battery is enabled. By setting the target output value to smooth the fluctuations in the generated power output in this manner, a contrivance at lengthening the lifetime of the battery is enabled while suppressing of the effects on the power grid caused by the fluctuations in the generated power output by the power generator.

### BRIEF DESCRIPTION OF THE DRAWINGS

FIG. 1 is a block diagram showing the configuration of the power generation system of one embodiment of the present invention.

FIG. 2 is a drawing to explain the relationship between the intensity of the load fluctuation output to the power grid and the fluctuation period.

FIG. 3 is a flow chart in order to explain the flow of the control of the charge and discharge control of the power generation system of one embodiment of the present invention shown in FIG. 1.

FIG. 4 is a drawing to explain the sampling period in respect of the charge and discharge control.

FIG. 5 is a graph showing one example (Example 1) of the trends of the one day actual generated power output of the power generator.

FIG. 6 is a graph showing one example (Example 1) of the trends of the one day power output to the power grid when the trend of the actual generated power output of the power generator is that shown for the power generator of FIG. 5 as a result of the power generation system of Embodiment 1.

FIG. 7 is a graph showing one example (Example 1) of the trends of the one day power output to the power grid when the trend of the actual generated power output of the power generator is that shown for the power generator of FIG. 5 as a result of the power generation system of the comparative example.

FIG. 8 is a graph showing the results of the FFT analysis (Example 1) of the actual power output of the power generator, the power output of the power generation system of Embodiment 1 and the power output of the power generation system of the comparative example.

FIG. 9 is a graph showing the trends of the capacity of the power storage cell (Example 1) when the generated power has the trends in generated power of the power generator shown in FIG. 5, using the power generation systems of the embodiment 1 and the comparative example.

FIG. 10 is a graph showing one example (Example 1) of the trends of the one day power output to the power grid when the trend of the actual generated power output of the power generator is that shown for the power generator of FIG. 5 as a result of the power generation system of Embodiment 2.

FIG. 11 is a graph showing the results of the FFT analysis (Example 1) of the actual power output of the power generator, the power output of the power generation system of Embodiment 2 and the power output of the power generation system of the comparative example.

FIG. 12 is a graph showing the trends of the capacity of the power storage cell (example 1) when the generated power has the trends in generated power of the power generator shown in FIG. 5, using the power generation systems of the embodiment 2 and the comparative example.

FIG. 13 is a graph showing one example (Example 2) of the trends of the one day actual generated power output of the power generator.

FIG. 14 is a graph showing one example (Example 2) of the trends of the one day power output to the power grid when the trend of the actual generated power output of the power generator is that shown for the power generator of FIG. 13 as a result of the power generation system of Embodiment 1.

FIG. 15 is a graph showing one example (Example 2) of the trends of the one day power output to the power grid when the trend of the actual generated power output of the power generator is that shown for the power generator of FIG. 13 as a result of the power generation system of the comparative example.

FIG. 16 is a graph showing the results of the FFT analysis (Example 2) of the actual power output of the power generator, the power output of the power generation system of Embodiment 1 and the power output of the power generation system of the comparative example.

FIG. 17 is a graph showing the trends of the capacity of the power storage cell (Example 2) when the generated power has the trends in generated power of the power generator shown in FIG. 13, using the power generation systems of the embodiment 1 and the comparative example.

FIG. 18 is a graph showing one example (Example 2) of the trends of the one day power output to the power grid when the trend of the actual generated power output of the power generator is that shown for the power generator of FIG. 13 as a result of the power generation system of Embodiment 3.

FIG. 19 is a graph showing the results of the FFT analysis (Example 2) of the actual power output of the power generator, the power output of the power generation system of Embodiment 3 and the power output of the power generation system of the comparative example.

FIG. 20 is a graph showing the trends of the capacity of the power storage cell (example 2) when the generated power has the trends in generated power of the power generator shown in FIG. 13, using the power generation systems of the embodiment 3 and the comparative example.

FIG. 21 is a graph showing one example (Example 2) of the trends of the one day power output to the power grid when the trend of the actual generated power output of the power generator is that shown for the power generator of FIG. 13 as a result of the power generation system of Embodiment 4.

FIG. 22 is a graph showing the results of the FFT analysis (Example 2) of the actual power output of the power generator, the power output of the power generation system of Embodiment 4 and the power output of the comparative example.

FIG. 23 is a graph showing the trends of the capacity of the power storage cell (example 2) when the generated power has the trends in generated power of the power generator shown in FIG. 13, using the power generation systems of the embodiment 4 and the comparative example.

Hereafter the embodiments of the present invention are explained based on the figures.

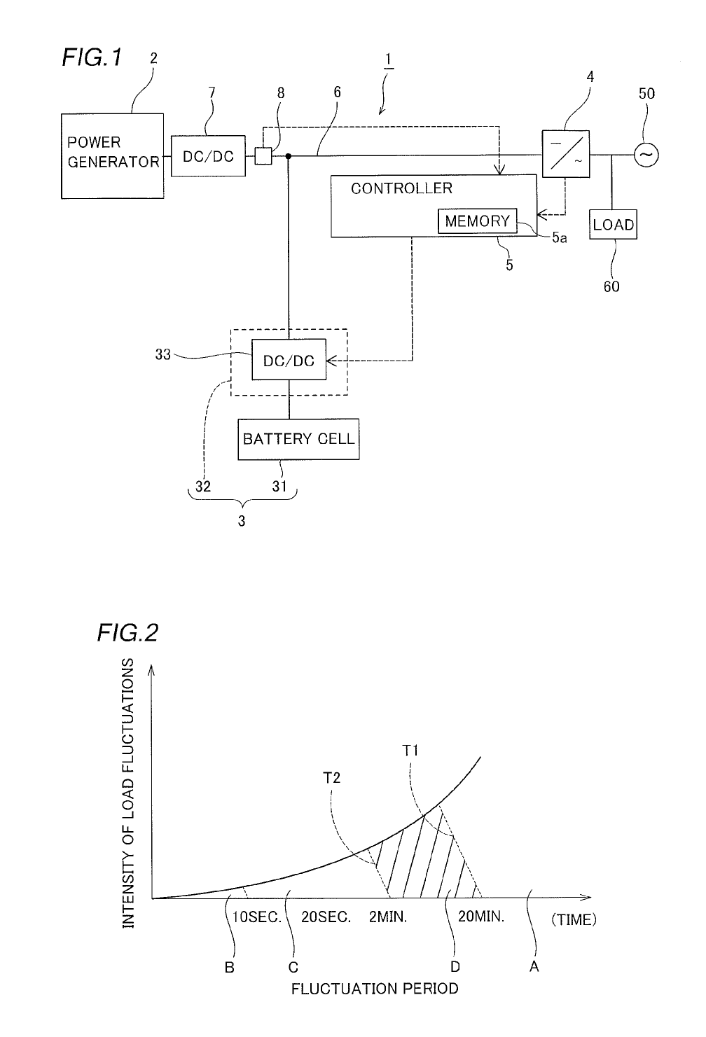

Firstly, the configuration of the power generation system of an embodiment of the invention is explained while referring to FIG. 1 and FIG. 2.

The power generation system 1 has the power generator 2 comprised of a solar cell electrical generator employing sunlight, connected to the power grid 50. The power generation system 1 provides an battery 3 enabling electrical storage of the power generated by means of the power generator 2, and an electrical power output unit 4 including an inverter which outputs electrical power stored by battery 3 as well as power generated by means of the power generator 2 to the power grid 50, and a controller 5 controlling the charging and discharging of the battery 3. Now, the power generator 2 is preferably a generator utilizing renewable energy and, for example, may employ a wind power generator and the like. Moreover, load 60 is connected to the alternating current bus connecting the power output unit 4 and the power grid 50.

The DC-DC converter 7 is connected in series on the bus 6 connecting the power generator 2 and the power output unit 4. The DC-DC converter 7 converts the direct current voltage of the power generated by the power generator 2 to a fixed direct current voltage (In this embodiment, approximately 260 V) and outputs to the power output unit 4 side. Moreover, the DC-DC converter 7 has a so-called a maximum power point tracking (MPPT) control function. The MPPT function is a function where by the operating voltage of the power generator 2 is automatically adjusted to maximize the power generated by the power generator 2. A diode is provided (not shown in the figures) between the power generator 2 and the DC-DC converter 7 so as to prevent the reverse flow of the current to the power generator 2.

The battery 3 includes the battery cell 31 connected in parallel with the bus 6, and the charge and discharge unit 32 which performs the electrical charge and discharge of the battery cell 31. As the battery cell 31, a high charge and discharge efficiency ratio rechargeable battery with low natural discharge (e.g. a lithium ion storage cell, a Ni-MH storage cell and the like) are employed. Moreover, the voltage of the battery cell 31 is approximately 48 V.

The charge and discharge unit 32 has a DC-DC converter 33, and the bus 6 and the battery cell 31 are connected via the DC-DC converter 33. When charging, the DC-DC converter 33 supplies electrical power from the bus 6 side to the battery cell 31 side by reducing the voltage of the bus 6 to a voltage suitable for charging the battery cell 31. Moreover, when discharging, the DC-DC converter 33 discharges the electrical power from the battery cell 31 side to the bus 6 side by raising the voltage from the voltage of the battery cell 31 to the vicinity of the voltage of the direct current bus 6 side.

The electrical controller 5 performs the charge and discharge control of battery cell 31 by controlling the DC-DC convertor 33. In order to smooth the value of the power output to the power grid 50, irrespective of the generated power output of the power generator 2, the controller 5 sets a target output value to the power grid 50. The controller 5 controls the charge and discharge of the battery cell 31 so that the power output to the power grid 50 becomes the target output value in correspondence with the generated power output of the power generator 2. In other words, in the event that the power output by the power generator 2 is greater than the target output value, the controller 5 not only controls the DC-DC converter 33 to charge the battery cell 31 with the excess electrical power, in the event that the power output by the power generator 2 is less than the target output value, the controller 5 controls the DC-DC converter 33 to discharge the battery cell 31 to make up for the shortfall in the electrical power.

Moreover, the controller 5 acquires the power output data from the detection unit 8 provided on the output side of DC-DC converter 7. The detection unit 8 detects the power output of the power generator 2 and transmits the power output data to the controller 5. The controller 5 acquires the power output data from the detection unit 8 at each of specific detection time intervals (e.g. not more than 30 seconds). Here, the power output data is acquired every 30 seconds. Now if the detection time interval of the power output data is too long or too short, the fluctuation in the power output cannot be detected accurately, it is set at an appropriate value in consideration of the fluctuation period of the power output of the power generator 2. In this embodiment, the detection time interval is set to be shorter than the lower limit period which the load frequency control (LFC) can deal with.

The controller 5, recognizes the difference between the actual power output by the power output unit 4 to the power grid 50, and target output value by acquiring the output power of the power output unit 4, and by this means, the controller 5 enables feedback control on the electrical charging and discharging by the charge and discharge unit 32 such that the power output from the power output unit 4 becomes that of the target output value.

Next, the charge and discharge control method of the power storage cell 31 by the controller 5 is explained.

As described above, the controller 5 controls the charge and discharge of the battery cell 31 so that the total of the power generated by the power generator 2, and the amount charged or discharged to/from the battery cell 31 becomes the target output value. The target output value is computed using the moving average method. The moving average method is a computation method for the target output value for a point in time, wherein the average value for the power output by the power generator 2 in a period from that point back to the past is computed.

The prior power output data was successively recorded in memory 5a. Hereafter, the periods in order to acquire the power output data used in the computation of the target output value are called the sampling intervals. As a specific example of the value for the sampling interval, in this embodiment the sampling interval is set at approximately 20 minutes and 30 seconds. In this situation, because the controller 5 acquires the power output data approximately every 30 seconds, the target output value is computed from the average value of 41 power output data samples in the last 20 minute 30 seconds interval.

But, for the target output value, if the moving average value computed using the moving averages method is used, as is, a slippage with respect to the actual power output by the power generator 2 is generated. For this reason, the controller 5 in computing the target output value, weights the most recent power output data samples in order that the target output value should approximate the actual generated power output. In the normal moving average method, the target output value is computed by taking a simple average of the previous 41 power output data samples (All 41 data samples have exactly the same weighting in computing the average). In contrast to this, in this embodiment, the weighting applied to the latest power output data is greater than that of the other 40 power output data samples, and by taking the average of all of these (a weighted average), a target output value is set where the latest power output value is more closely represented. Because the target output value computed from this type of weighted average becomes a power output value which is closer to the latest generated power output than a target output value which is a simple average, the difference between the target output value and the latest generated power output value is reduced.

Moreover, when the amount of fluctuation in the power output of power generator 2 is greater than a specific threshold value, the controller 5 computes the target output value while applying a greater weighting value in the computation method thereof. The computation of the amount of fluctuation in the generated power is performed every time the power output data is acquired, and the determination of whether the amount of the fluctuation is greater than the threshold is also performed on that same occasion. Moreover, if the fluctuation in the amount of power generated is not more than the threshold value, the target output value is computed by the normal moving averages method (simple average), without recourse to the application of a weighting. In this embodiment, the threshold value is a fluctuation amount which is less than a control initiating fluctuation amount, and specifically is 3% of the rated power output of the power generator 2.

The computation of the target output value by means of the weighted average and the computation of the target output value by means of the simple average are each performed, respectively, by means of the following equations (1) and (2). Now, in equations (1) and (2), the detection time interval is set as i, the sampling period T, the weighting function n, the generated power output at time t is P(t), and the target output value at time t is set as Pm(t).

$$\begin{matrix}Pm ( t ) = [ ( P ( t ) \times n ( T - i ) / i ) + {\sum }_{i - T + i}^{t - i} P ( t ) ] / ( ( T - i ) / i + n ( T - i ) / i ) & ( 1 ) \\ Pm ( t ) = [ P ( t ) + {\sum }_{t - T + i}^{t - i} P ( t ) ] / ( T / i ) & ( 2 )\end{matrix}$$

As shown in equation (1), the target output value Pm(t) by means of the weighted average is derived from the sum of the power output data from time point t−T+i to time point t−i (The number of data samples is (T−i)/i samples), with the addition of the weighted value for the power output data P(t) at time point t(The number of data samples is n(T−i)i samples), divided by the total number of data samples included ((T−i)i+n (T−i)i). On the other hand, as shown in equation (2), the target output value Pm(t) by means of the simple average is derived from the sum of the power output data from time point t−T+i to time point t, divided by the total number of data samples included (T/i). Furthermore, in the event of n=i/(T−i), the values of equations (1) and (2) become equal, and in the case of n>i/(T−i), the value of equation (1) is nearer to the value of P(t) than that of equation (2). Moreover, the greater the added weighting function n in equation (1), the nearer the target output value Pm(t) value is to P(t).

Furthermore, after the controller 5 initiates the charge and discharge control, the charge and discharge control is terminated after a specific time point (for example, at 17:00 hours, or such like).

Moreover, the controller 5 does not perform the charge and discharge control when adverse effects would be small even if the generated power of the power generator 2 is output to the power grid 50, and the controller 5 only performs the charge and discharge control when the adverse effects would be great. Specifically, the charge and discharge control is initiated in the event that the fluctuation amount in the power generated by power generator 2 is not less than a specific amount of fluctuation (hereafter referred to as “the control initiating fluctuation amount”). As a specific numerical value for the control initiating fluctuation amount, for example, 5% of the rated power output of the power generator 2. Furthermore, the amount of fluctuation in the generated power output is acquired by computing the difference in two consecutive power output data samples detected at each of specific detection time intervals.

Next, while referring to FIG. 2, an explanation is provided on the fluctuation period range performed largely by the fluctuation suppression effected by means of the charge and discharge control by the controller 5. As shown in FIG. 2, the control method which enabled a response to the fluctuation period is different. The load fluctuation periods which load frequency control (LFC) can deal with are shown in domain D (The domain shown hatched). Moreover, the load fluctuation periods which EDC can deal with are shown in domain A. Now domain B is a domain in which the load fluctuation can be absorbed naturally by the endogenous controls of the power grid 50. Furthermore, domain C is a domain which can be dealt with by the governor free operation of each of the power generator of the generating stations.

Here, the load fluctuation period which can be dealt with by LFC at the border of domain D and domain A becomes the upper limit period T1, and the load fluctuation period which can be dealt with by load frequency control at the border of domain C and domain D becomes the lower limit period T2. The upper limit period T1 and the lower limit period T2 are not fixed periods, but it can be appreciated that they are numerical values which vary with the size of the load fluctuations. In addition, the time of the fluctuation period shown in the figures will vary with the architecture of the power grid. For example, the values of the lower limit period T2 and the upper limit period T1 will vary as a result of the effects of the so called “run-in” effect on the power grid side. Furthermore, the size of the run-in effect will vary with the degree of installed base of solar electric generation systems and their regional distribution, In this embodiment, the focus is on the fluctuation periods in the range of domain D (the domain which can be dealt with by LFC) which is the range where EDC, the endogenous control of the power grid 50 or the governor free operation cannot deal with, and the objective is to suppress them.

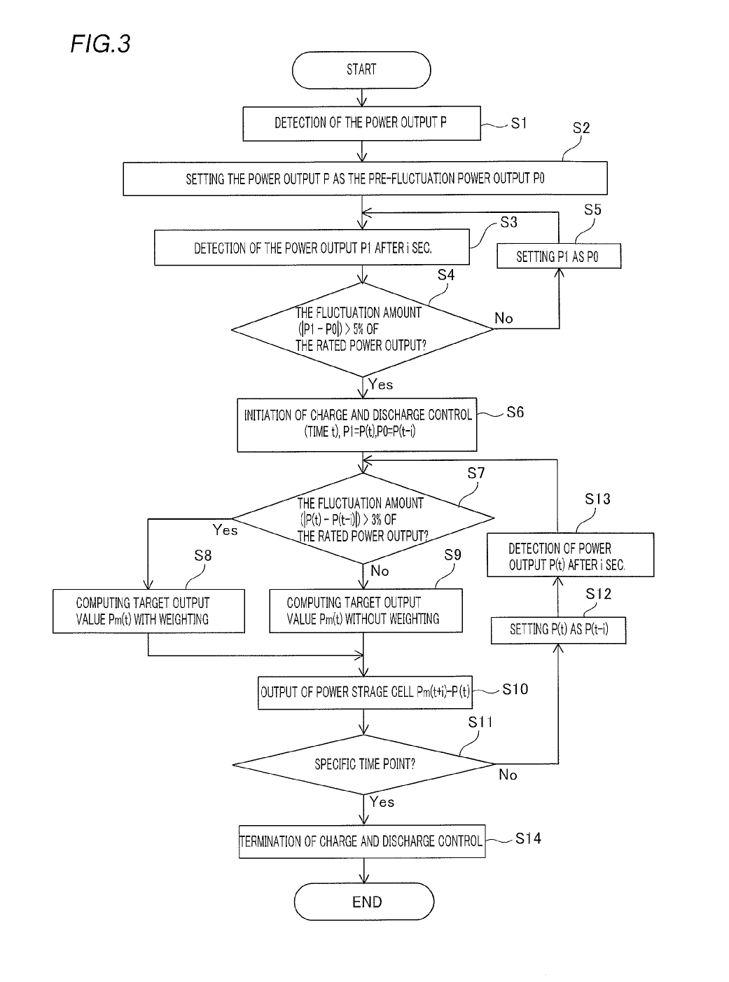

Next, an explanation is provided of the control flow of the power generation system 1 while referring to FIG. 3.

Firstly, in step S1, the controller 5 detects the power output P of the power generator 2 at a particular point in time. Then, in step S2, the controller 5 sets the detected power output P as the pre-fluctuation power output P0. Next, in step S3, the controller 5 detects the generated power output again, after i (i is the detection time interval) seconds have elapsed since the detection of the power output P0, and sets that detected value as P1.

Thereafter in Step S4, the controller 5 makes a determination as to whether the fluctuation amount in the power generated (|P1−P0|) is greater than the control initiating fluctuation amount or not (5% of the rated power output of the power generator 2). If the fluctuation amount in the power generated is not more than the control initiating fluctuation amount, the controller 5 sets P1 as P0 in step S5 and acquires the value of P1 to monitor the fluctuation in the power generated in Step S3.

When the amount of fluctuation in the generated power output is greater than the control initiating fluctuation amount, in Step S6, the controller 5 initiates charge and discharge control. In other words, the target output value is computed based on the generated power output in the previous 20 minutes 30 seconds, and the controller 5 controls the charge and discharge of battery cell 31 so that the target output value is output by the power output unit 4. In the explanations hereafter, the starting point of the charge and discharge control are set as time point t, and the power output P1 and P0 at the starting point are referred to as the power output P(t) and P(t−i), respectively.

Moreover, simultaneous with the initiation of the charge and discharge control (time point t), in step S7, the controller 5 determines whether the fluctuation amount of the generated power output (|P(t)−P(t−i)|) is greater than a specific threshold value (3% of the rated power output of the power generator 2). In the event that the amount of fluctuation is greater than the threshold, in step S8, the target output value Pm(t) with weighting is computed. In other words, the target output value Pm(t) is computed using the weighted average of equation (1) above in order that the target output value should more closely approximate the post fluctuation power output P(t) than if no weighting was employed. Moreover, when the amount of fluctuation in the generated power output is not more than the threshold value, in step S9, the target output value Pm(T) is computed without weighting. In other words, the target output value Pm(t) is computed by means of a simple average of the power output data samples included in the sampling period as equation (2) above.

Thereafter, in step S10, the controller 5 charges and discharges the difference (Pm(t)−P(t)) between the target output value Pm(t) and the power output P(t) to/from battery cell 31 in the interval from time t˜time t+i. Now, in the event that (Pm(t)−P(t)) is a positive value, that difference is a charging of the battery cell 31, and if a negative value, that difference represent a discharge of battery cell 31.

Thereafter, in step S11, the controller 5, determined whether a specific time point has been reached or not. When the specific time is reached, the controller 5 terminates the charge and discharge control in step S14. Moreover, if the specific time is not reached, the charge and discharge control is continued. In this situation, in step S12, the controller 5 after the power output P(t) becomes P(t−i), in step S13, detects the power output P(t). Now, the power output P(t) in step S13 is the power output i seconds after the power output P(t) in the immediately previous steps S7˜S10. Then, the steps S7˜S13 are repeated until that specific time is reached.

The power generation system 1 of this embodiment enables the following benefits by means of the configuration described above.

In the event that the amount of fluctuation in the generated power output of the power generator 2 is greater than the threshold value, the controller 5 computes a target output value by means of weighted average, with a large weighting towards the post-fluctuation power output in order that the target output value should approximate the post-fluctuation power output. By means of this type of configuration, the value of the target output value can be caused to more closely resemble the post-fluctuation power output. By this means, in the event that the actual generated power output fluctuates by a large amount, because the target output value is caused to fluctuate greatly in accordance with that fluctuation in the generated power output, the suppression of the generation of a big difference between the target output value and the generated power output is enabled. By this means, because the amount of charging and discharging of the battery 3 which corresponds to the difference between the target output value and the generated power output can be reduced, a contrivance at lengthening the lifetime of the battery 3 is enabled. Moreover, by setting the target output value so as to smooth the fluctuation in the generated power output in this manner, the contrivance at lengthening the lifetime of the battery 3 is enabled while suppressing the effects caused by the fluctuations in the generated power output by the power generator 2 on the power grid 50.

In the event that the amount of fluctuation in the power output of the power generator 2 is not more than the threshold value, the controller 5 computes a target output value by means of a simple average, without performing a weighting of the generated power output to that of after the fluctuation. By means of this type of configuration, when the fluctuation in the power output is less and the amount of charge and discharge of the battery 3 will not be great even without the application of the weighting, because the target output value can be computed without performing any weighting, suppression of the fluctuation is enabled sufficiently by means of the target output value while performing smoothing.

Furthermore, in the event that the amount of fluctuation in the power output of the power generator 2 is greater than the control initiation fluctuation amount, the controller 5 initiates control of the computation of the target output value. By means of this type of configuration, the computation of the target output value is not performed when the fluctuation in the amount of the generated power output is less than the control initiating fluctuation amount, and because the charge and discharge of the battery 3 is not performed, the number of charge and discharge events of battery 3 can be reduced. By this means, a contrivance at lengthening the lifetime of the battery 3 even further is enabled.

Moreover, by enabling a detection time interval at an interval which is less than the lower limit of the fluctuation periods which the load frequency control can deal with, and by detection of the fluctuations in the generated power output based on the power output acquired in this type of detection time interval, the controller 5 can easily detect fluctuations in the generated power output which have fluctuation periods which the load frequency control can deal with. By this means, charge and discharge control is enabled while reducing the fluctuation components of the fluctuation periods which the load frequency control can deal with.

Furthermore, by means of a period which is not less than the lower limit period of the fluctuation periods which the sampling period of the load frequency control can deal with, the charge and discharge control 5 by computing the target output value by means of the moving average method based on the power output data acquired in this type of period range, enables a reduction in the components of the fluctuation periods which the load frequency control, in particular, can deal with. By this means, suppression of the effects on power grid 50 is enabled.

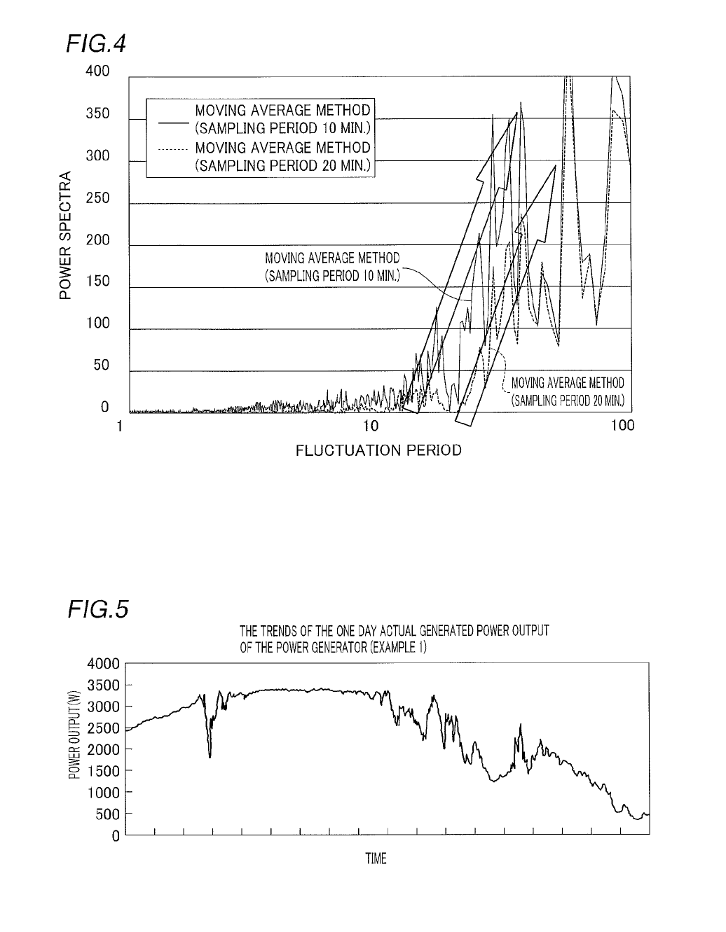

Next, the results of an investigation of the sampling periods of the moving average method are explained while referring to FIG. 4. FIG. 4 shows the results of the FFT analysis of the power output data when the sampling period which is the acquisition period of the power output data was 10 minutes, and the results of the FFT analysis of the power output data when the sampling period was 20 minutes.

As shown in FIG. 4, when the sampling period was 10 minutes, while the fluctuations in respect of a range of up to 10 minutes of a fluctuation period could be suppressed, the fluctuations in a range of fluctuation periods which were not less than 10 minutes were not suppressed well. Moreover, when the sampling period was 20 minutes, while the fluctuations in respect of a range of up to 20 minutes of a fluctuation period could be suppressed, the fluctuations in a range of fluctuation periods which were not less than 20 minutes was not suppressed well.

Therefore, it can be understood that there is a good mutual relationship between the size of the sampling period, and the fluctuation period which can be suppressed by the electrical charge and discharge control. For this reason, it can be said that by setting the sampling period, the range of the fluctuation period which can be controlled effectively changes. In that respect, in order to suppress parts of the fluctuation period which can be addressed by the load frequency control which is the main focus of this system, it can be appreciated that in order that sampling periods which are not less than the fluctuation period corresponding to what the load frequency control can deal be set, in particular, it is preferable that they be set from the vicinity of the latter half of T1˜T2 (The vicinity of longer periods) to periods with a range not less than T1. For example, in the example in FIG. 2, by utilizing a sampling period of not less than 20 minutes, it can be appreciated that suppression of most of the fluctuation periods corresponding to the load frequency control is enabled. However, when the sampling period is made longer, there is a tendency that the required battery capacity grows large, and it is preferable to select a length of sampling period which is not much longer than T1.

Next, an explanation is provided of the results of a simulation to investigate the effectiveness of the performance of charge and discharge control of this invention while referring to FIG. 5˜FIG. 23.

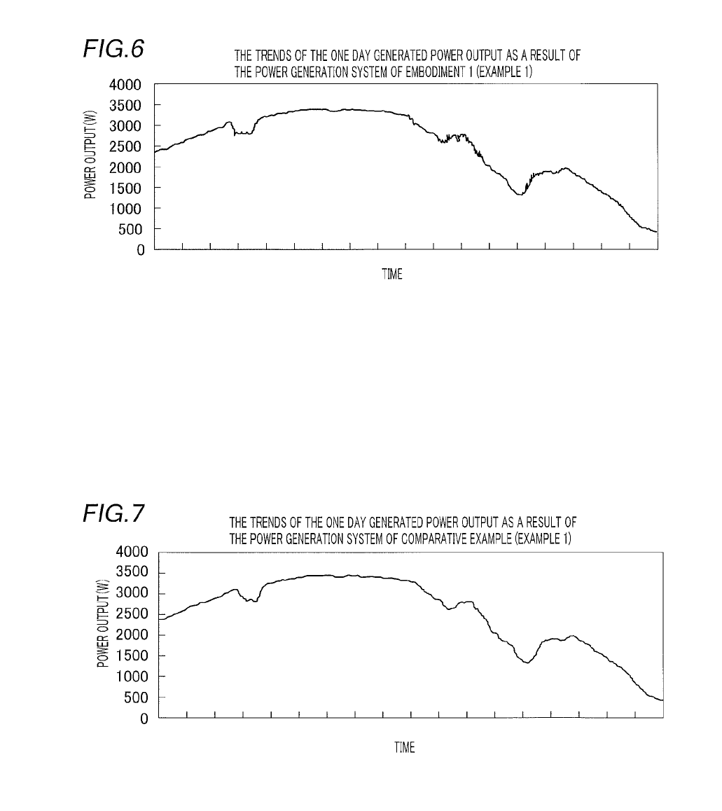

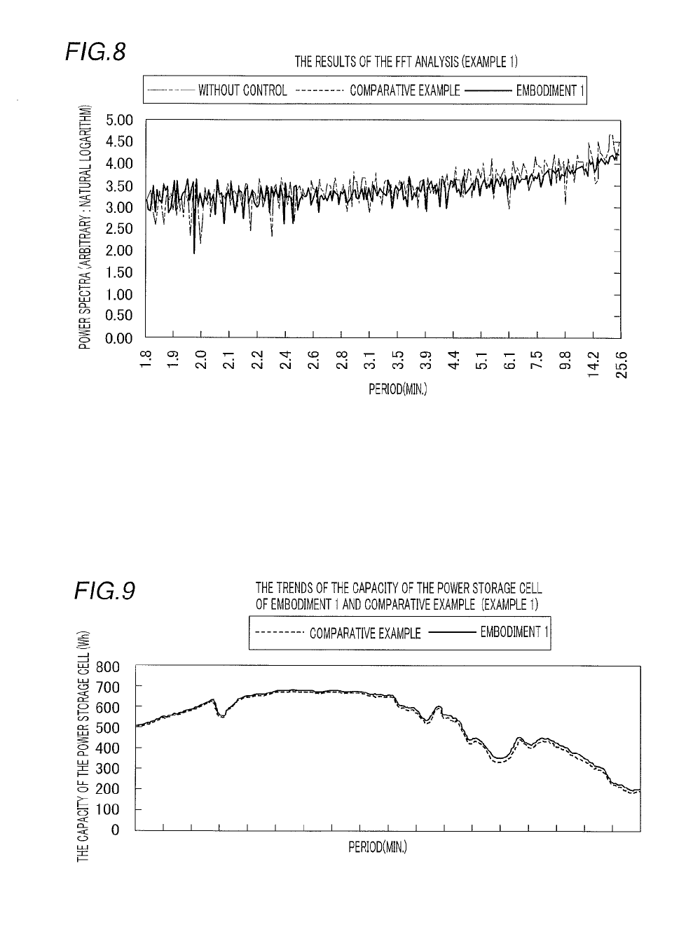

Firstly, an explanation is provided of the results of the simulation to investigate the effectiveness of the performance of charge and discharge control of this invention (example 1) while referring to FIG. 5˜FIG. 9. FIG. 5 shows the one day trend of the actual generated power output of a power generator with a rated power output of 4 kW (example 1). FIG. 6 shows the simulation results of the trends of the one day power output to the power grid when the trend of the actual generated power output of the power generator is that shown for the power generator of FIG. 5 as a result of the power generation system of embodiment 1. FIG. 7 shows the simulation results the trends of the one day power output to the power grid when the trend of the actual generated power output of the power generator is that shown for the power generator of FIG. 5 as a result of the power generation system of the comparative example. FIG. 8 shows the results of the FFT analysis of the power output of the actual power generator, the power output of the power generation system of embodiment 1 and the power output of the power generation system of the comparative example.

Now, in embodiment 1, the weighting function n was set to 0.25, and the specific threshold was set to 3% of the rate power output of the power generator, in a configuration of this embodiment where the target output value was computed by the moving average method of either the weighted average or the simple average. In the configuration of the comparative example, the target output value was computed by only the moving average method of the simple average. Moreover, in embodiment 1 and the comparative example, the charge and discharge control was initiated when the amount of the fluctuation of the generated power output exceeded 5% of the rated power output of the power generator, and the charge and discharge control was terminated at a specific time (17:00 hours). Moreover, FIG. 9 shows the trends of the capacity of the power storage cell using the power generation systems of the embodiment 1 and the comparative example.

As shown in FIGS. 5˜7, it can be appreciated that in both the embodiment 1 and the comparative example, the smoothing of the fluctuations in the generated power of the power generator shown in FIG. 5, was enabled. As shown in FIG. 8, it can be appreciated that in the FFT results, the actual generated power output, and embodiment 1 and the comparative example are substantially the same. This is because the fluctuations in the actual power generated originally in example 1 were small, and so whether smoothing is performed using either embodiment 1 or the comparative example, there is little difference.

Furthermore, as shown in FIG. 9, it can be appreciated that in example 1, there is little difference between embodiment 1 and the comparative example, and the trends in the capacity are substantially the same. In this simulation result, the amount of charging and discharging in embodiment 1 and the comparative example were 1290 Wh and 1324 Wh, respectively. In other words, in the situation where the fluctuations in the power generated were small, the amount of charging and discharging in embodiment 1 was slightly smaller (34 Wh) than in the comparative example.

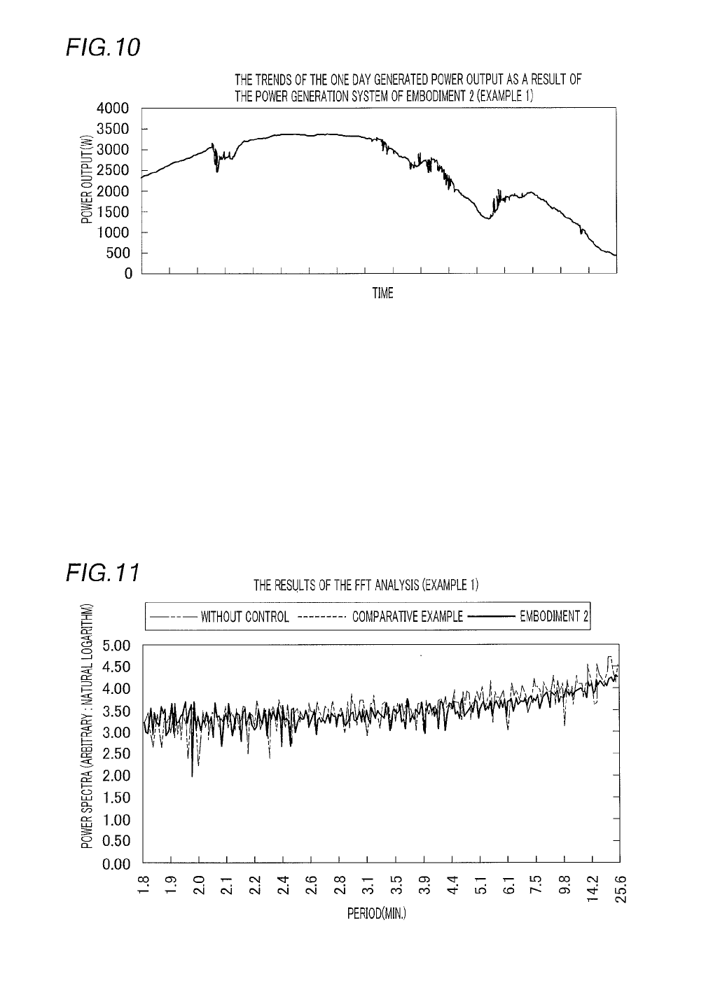

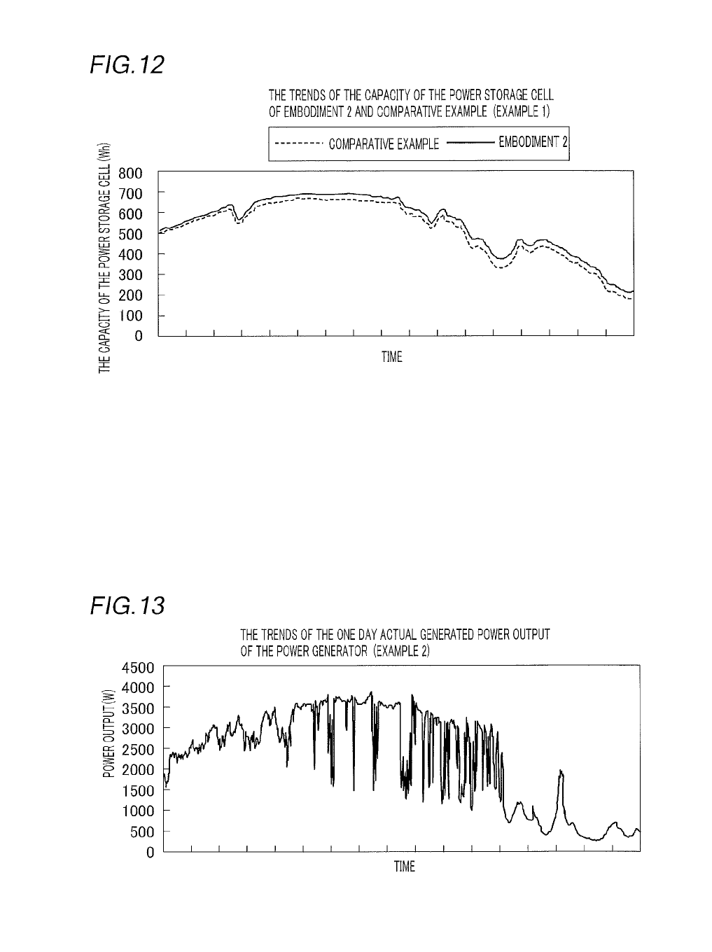

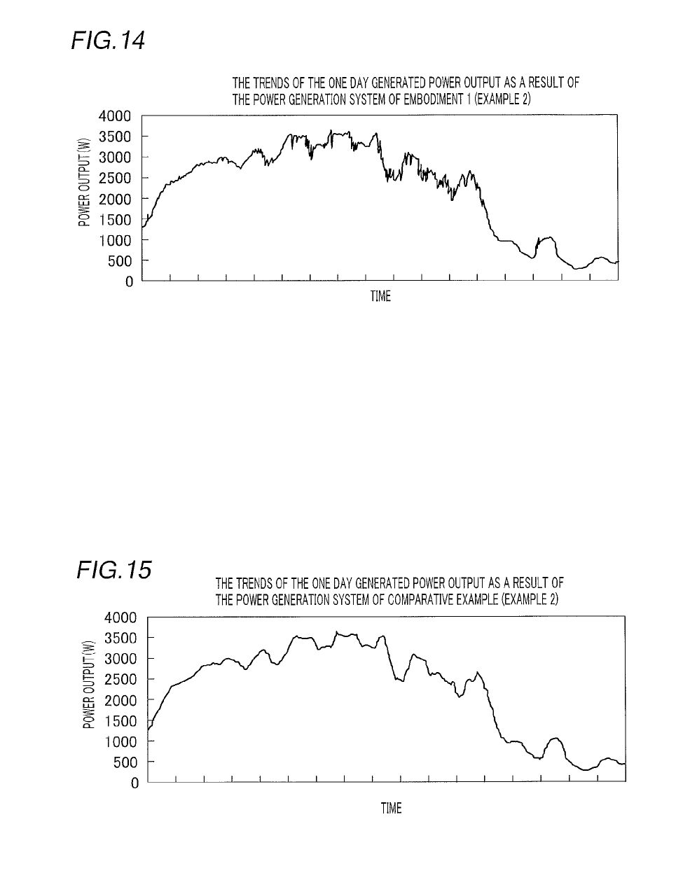

Next, an explanation is provided of the simulation results when charge and discharge control was performed by means of embodiment 2 in respect of the trends in the power output generated shown in FIG. 5. FIG. 10 shows the trends of the one day power output to the power grid when the trend of the actual generated power output of the power generator is that shown for the power generator of FIG. 5 as a result of the power generation system of Embodiment 2. FIG. 11 shows the results of the FFT analysis of the power output of the actual power generator, the power output of the power generation system of embodiment 2 and the power output of the power generation system of the comparative example. Now in embodiment 2, unlike in embodiment 1, the configuration was one where the charge and discharge control was performed with the weighting function was set at 1.00 (The threshold was 3% of the rated power output). Moreover, FIG. 12 shows the trends of the capacity of the power storage cell using the power generation systems of the embodiment 2 and the comparative example.

As shown in FIG. 10, it can be appreciated that even in embodiment 2, the smoothing of the fluctuations in the generated power output of the power generator as shown in FIG. 5 was enabled. Furthermore, as shown in FIG. 11, it can be appreciated that just as in embodiment 1, in the FFT analysis results, the actual generated power output, the embodiment 2 and the comparative example were substantially the same. As shown in FIG. 12, it can be appreciated that in the case of embodiment 2, the difference from the comparative example is greater than it was in embodiment 1. In the simulated result there, the amounts of charging and discharging for the embodiment 2 and the comparative example were, 1234 Wh and 1324 Wh, respectively. In other words, in embodiment 2 where the weight function n was set larger than in embodiment 1, the reduction in the charge and discharge amount realized was 90 Wh, and it can be appreciated that compared with embodiment 1 where the amount of reduction in the charge and discharge amount was small (reduced amount of 34 Wh), the difference in the reduction of the charge and discharge amount compared with the comparative example is great.

Next, show the results of an investigation of the simulation of the performance of charge and discharge control (example 2) of the present invention while referring to FIGS. 13˜17. Unlike embodiment 1, FIGS. 13˜17 relate to example 2 where the fluctuation in the generated power output were large, but correspond to the simulations results shown in FIGS. 5˜9.

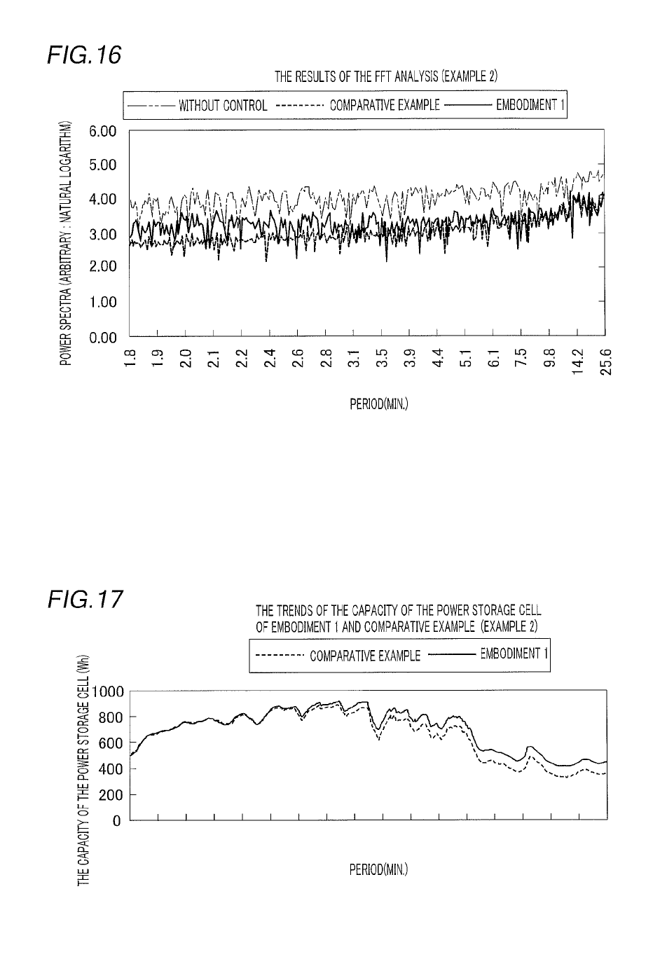

As shown in FIGS. 13˜15, it can be appreciated that smoothing of the fluctuations in the generated power output of the power generator as shown in FIG. 13 with both the embodiment 1 and the comparative example was enabled. Moreover, as shown in FIG. 16, it can be appreciated that even in the results of the FFT analysis both the embodiment 1 and the comparative example enabled suppression of the large scale fluctuations in the actual power output generated. In particular, in the embodiment 1, in a comparison of the fluctuation periods of approximately 2 to 20 minutes, there was substantially the same level of suppression. In other words, while the degree of suppression of the fluctuation periods of approximately 2˜3 minutes was smaller with the embodiment 1 than with the comparative example, in the 3˜20 minute fluctuations, the same degree of suppression was enabled.

Moreover, as shown in FIG. 17, in the case of the example 2, compared with the example 1 (see FIG. 9), it can be appreciated that a big difference in the capacity sustenance ratio between embodiment 1 and the comparative example was enabled. In these simulation results, the amounts of charge and discharge for the embodiment 1 and the comparative example were 3041 and 3239 Wh, respectively. In other words, in the situation where the fluctuations in the generated power output were greater, it can be appreciated that compared to the comparative example, the embodiment 1 enabled a large reduction in the amount of charge and discharge (approximately 200 Wh).

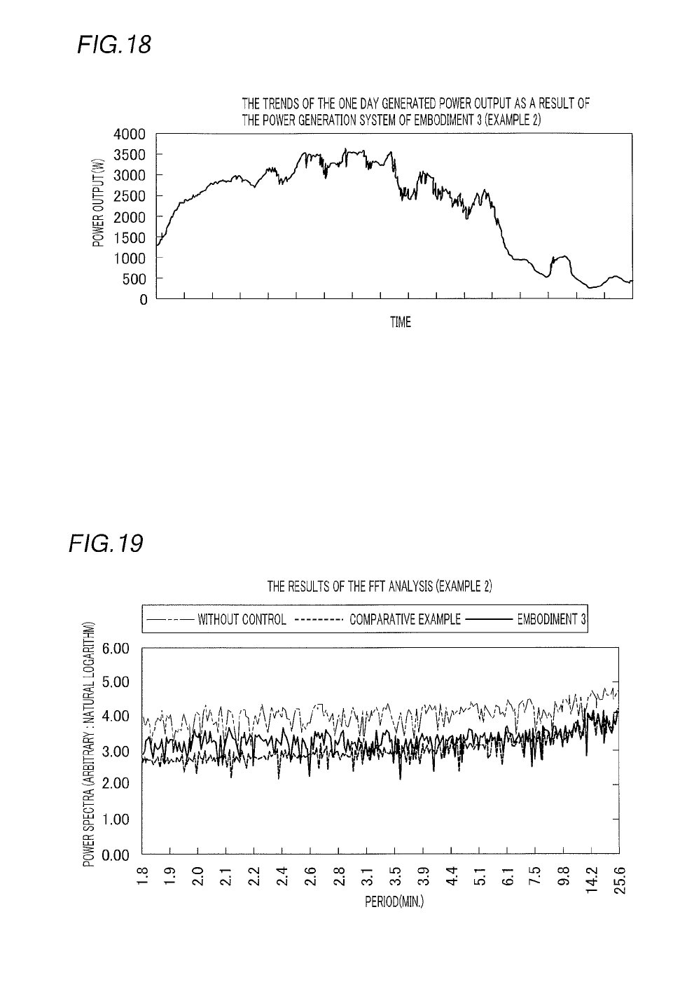

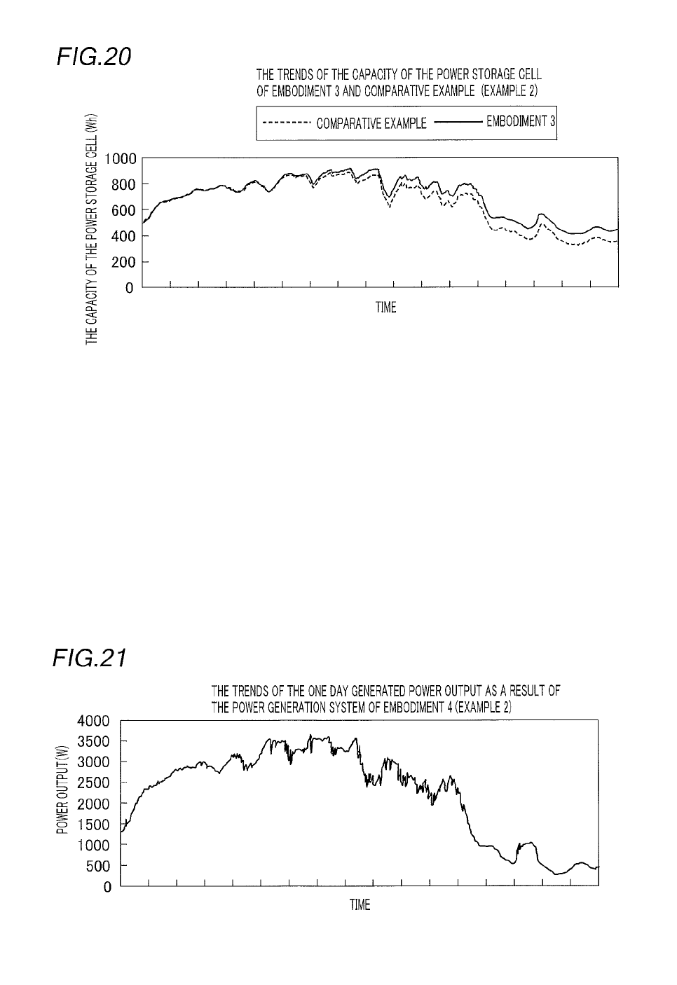

Next, an explanation is provided of the simulation results for the charge and discharge control in embodiment 3 in respect of the trends in the generated power output (example 2) shown in FIG. 13. FIG. 18 shows the trends of the one day power output to the power grid when the trend of the actual generated power output of the power generator is that shown for the power generator of FIG. 13, as a result of the power generation system of Embodiment 3. FIG. 19 shows the results of the FFT analysis of the power output of the actual power generator, the power output of the power generation system of embodiment 3 and the power output of the power generation system of the comparative example. In embodiment 3, unlike in embodiment 1, the configuration set the weighting function n at 0.25, the specific threshold was set at 5% of the rated power output of the power generator and charge and discharge control were performed. FIG. 20 shows the trends of the capacity of the power storage cell using the power generation systems of the embodiment 3 and the comparative example.

As shown in FIG. 18, even in embodiment 3, it can be appreciated that smoothing of the fluctuations in the generated power output of the power generator as shown in FIG. 13 was enabled. Moreover, as shown in FIG. 19, it can be appreciated that even in the results of the FFT analysis, both the embodiment 3 and the comparative example enabled suppression of the large scale fluctuations in the actual power output generated. In regard to the degree of suppression enabled in embodiment 3, the degree of suppression was substantially the same as enabled in embodiment 1. Furthermore, as shown in FIG. 20, even in the case of embodiment 3, just as was the case in embodiment 1, (Refer to FIG. 17), it can be appreciated that the difference from the comparative example is great. In these simulation results, the amounts of charge and discharge for the embodiment 3 and the comparative example were 3077 and 3239 Wh, respectively. In other words, in embodiment 3 where the threshold was set greater than in embodiment 1, the reduction in the amount of charge and discharge achieved was 162 Wh, and compared to embodiment 1 (a reduction of 198 Wh compared to the comparative example), while the reduction in the amount of charge and discharge was less, it can be appreciated that there still was a big reduction in the amount of charge and discharge compared with the comparative example.

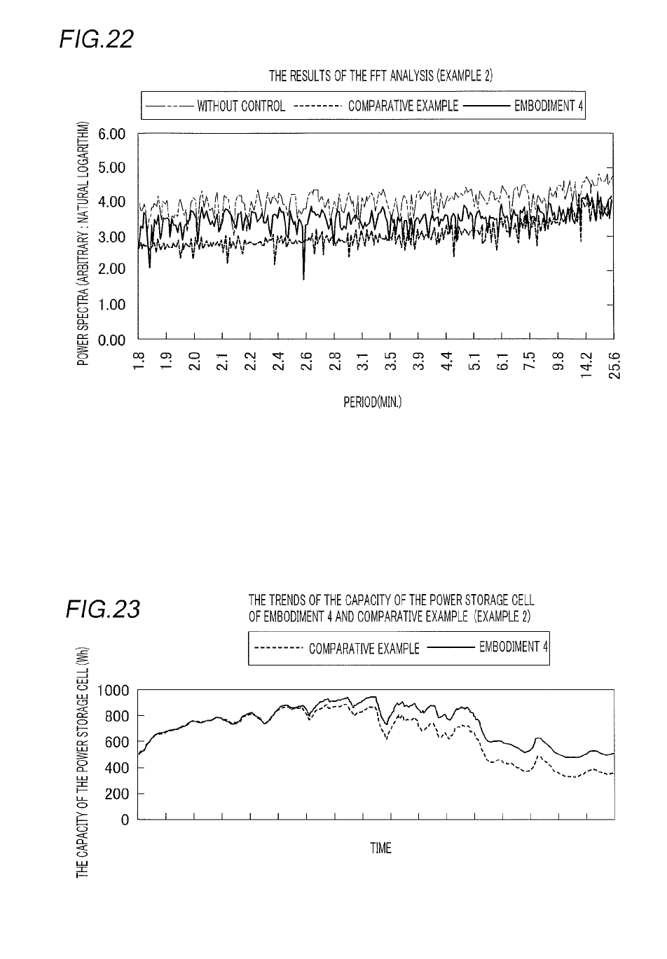

Next, an explanation is provided of the simulation results for the charge and discharge control in embodiment 4 in respect of the trends in the generated power output (example 2) shown in FIG. 13. FIG. 21 shows the trends of the one day power output to the power grid when the trend of the actual generated power output of the power generator is that shown for the power generator of FIG. 13 as a result of the power generation system of Embodiment 4. FIG. 22 shows the results of the FFT analysis of the power output of the actual power generator, the power output of the power generation system of embodiment 4 and the power output of the comparative example. Now in embodiment 4, unlike in embodiment 1, the configuration set the weighting function n to 0.50, the specific threshold value was set to 3% of the rate power output of the power generator and charge and discharge control were performed. Moreover, FIG. 23 shows the trends of the capacity of the power storage cell using the power generation systems of the embodiment 4 and the comparative example.

As shown in FIGS. 21˜23, even in embodiment 4, it can be appreciated that smoothing of the fluctuations in the generated power output of the power generator as shown in FIG. 13 was enabled. Moreover, as shown in FIG. 22, it can be appreciated that even in the results of the FFT analysis, that the degree of suppression achieved in embodiment 4 was less than the degree of suppression achieved in embodiment 1. In particular, it can be appreciated that the degree of suppression was less in the fluctuation period from approximately 2˜6 minutes. On the other hand, as shown in FIG. 23, in embodiment 4, compared with the situation with embodiment 1 (see FIG. 17) it can be appreciated that the difference from the comparative example is great. In these simulation results, the amounts of charge and discharge for the embodiment 4 and the comparative example were 2891 and 3239 Wh, respectively. In other words, in embodiment 4 where the weighting function n was set greater, the reduction in the amount of charge and discharge became 352 Wh, and compared to embodiment 1 (a reduction of 198 Wh compared to the comparative example), a big reduction in the amount of charge and discharge was enabled compared with embodiment 1.

In summing up the simulation results described above, the larger the weighting function, not only was the alleviation effect on the charge and discharge amount greater, the lower the threshold set, the larger the alleviation effect on the charge and discharge amount. Moreover, the larger the fluctuations in the generated power output, it can be appreciated that the larger were the alleviation effects on the amount of charge and discharge enabled by the present invention. Furthermore, when the weighting function was set at 0.25, the suppression of fluctuation periods which could be dealt with by the load frequency control was enabled, but when the weighting function was set at 0.50, the degree of suppression of fluctuation periods which could be dealt with by the load frequency control was less. In other words, it can be appreciate that there is a mutual correlation between the value of the weighting function and the suppressed fluctuation periods. From these results, it is proposed that in a situation where the fluctuations in the actual power generated are great, by setting appropriate weighting function values and threshold values, while achieving the same suppression of fluctuation periods by means of the load frequency control as with the conventional smoothing control (The comparative example), it is possible to reduce the amount of charge and discharge compared with the conventional smoothing control (The comparative example).

Now in the embodiments and example disclosed here, it should be considered that all points were for the purposes of illustration and the invention is not limited to those points. The scope of the present invention is not defined by those embodiments explained but by the scope of the claims of the invention, and in addition, all equivalent meaning to the scope of the claims and all modifications within the range of the scope of the claims are included in the invention.

For example, in the embodiments described above, an explanation was provided of embodiments where the voltage of the battery cell 31 was 48V, but this invention is not limited to this, and voltages other than 48 V may be employed. Now the voltage of the battery cell is preferably below 60V.

Furthermore, in the embodiments described above, embodiments were described wherein the control initiating fluctuation amount was set at 5% of the rated power output of the power generator 2, but this invention is not limited to this, and a value other than that cited above may be employed. For example, the control initiating fluctuation amount can be set at standard of the pre-fluctuation amount.

Furthermore, in the embodiments described above, an explanation was provided whereby the power consumption in the consumer home was not taken into consideration in the load in the consumer home, but this invention is not limited to this, and in the computation of the target output value, a power is detected wherein at least part of the load is consumed at the consumer location, and the computation of the target output value may be performed considering that load consumed power output or the fluctuation in the load consumed power output.

Moreover, in the sampling periods described in the embodiments, in regard to the specific values of the bus voltages and the like, they are not limited to these in this invention, and may be modified appropriately.

Moreover, in the embodiment described above, an embodiment was explained wherein the charge and discharge control was terminated based on the time of the day, but this embodiment is not limited to that, and the charge and discharge control may be terminated a fixed time after initiation or terminated when a determination is reached that the fluctuation in the amount of power generated grows smaller.

Furthermore, in the embodiments described above, an embodiment was described wherein the generated power output difference was detected by the detection unit 8, but this invention is not limited to this, and the detection of a power which reflects the generated power output may be used. For example, the amount of fluctuation in the power generated may be detected by the difference in the power selling (the power subtracted the power consumed by the load 60 from power generated) may be detected.

Moreover, in the embodiments described above, an explanation was provided wherein the control initiating fluctuation amount was less than a specific threshold value (3% of the rated power output), the present invention is not limited to this, and may be a value not less than the control initiating fluctuation amount.

Moreover, in the embodiments described above, the target output value was computed from a weighted average when the amount of fluctuation was greater than a specific threshold value, and an example where the target output value was computed where the simple average value was computed when not more than the specific threshold, but the present invention is not limited to these, and the target output value may be computed using a weighted average wherein a big weighing is applied when greater than a specific threshold value, or where the target output value is calculated using a small weighted average when not more than a specific threshold value. Moreover, when the charge and discharge is performed, a configuration may be employed wherein the target output value is computed from a weighted average wherein a standard weighting is applied normally.

1. A method of controlling a battery storing electric power generated by a power generator generating electric power using renewable energy, the method comprising:
detecting a power output data at plural points in time during a specified period, the power output data being amounts of electric power generated by the power generator;
computing a target output value for supplying to an electric power transmission system based on an average value of the power output data detected at the plural points; and
supplying to the electric power transmission system electric power corresponding to the target output value from at least one of the power generator and the battery,
wherein the average value is determined so that different weights are applied to the power output data detected at the plural points in calculating the average value.

2. The method of claim 1, further comprising computing a power difference between the power output data at two different points of the plural points and comparing the power difference and a predetermined first threshold value, wherein the different weights are applied to the power output data when the power difference is greater than the first threshold value.

3. The method of claim 2, wherein the different weights are applied to the power output data when the power difference is less than the first threshold value.

4. The method of claim 1, wherein the different weights are applied to the power output data such that a weight applied to the power output data at a first point is greater than a weight applied to the power output data at a second point earlier than the first point.

5. The method of claim 2, wherein the first threshold value is a specific proportion in respect of a rated power output of the power generator.

6. The method of claim 1, further comprising computing a power difference between the power output data at two different points of the plural points and comparing the power difference and a predetermined second threshold value, and supplying electric power to the electric power transmission system from the power generator without further computing the target output value, when the power difference is greater than the second threshold value.

7. The method of claim 2, wherein electric power is supplied to the electric power transmission system from the power generator without further computing the target output value, when the power difference is greater than a second threshold value, and the first threshold value is smaller than the second threshold value.

8. The method of claim 2, wherein the two different points of the plural points are consecutive points for the detection.

9. A computer-readable recording medium which records a control programs for causing one or more computers to perform the steps comprising:
detecting a power output data at plural points in time during a specified period, the power output data being amounts of electric power generated by the power generator;
computing an average value of the power output data detected at the plural points so that so that different weights are applied to the power output data detected at the plural points in calculating the average value;
computing a target output value for supplying to an electric power transmission system based on the average value; and
supplying to the electric power transmission system electric power corresponding to the target output value from at least one of the power generator and the battery.

10. An electric power generation system, comprising:
a power generator configured to generate electric power using renewable energy;
a battery configured to store electric power generated by the power generator;
a detector configured to acquire power output data at plural points in time during a specified perios, the power output data being the amount of electric power generated by the power generator; and
a controller configured to compute an average value of the power output data detected at the plural points so that different weights are applied to the power output data detected at the plural points in calculating the average value, to compute a target output value for supplying to an electric power transmission system based on the average value, to supply to the electric power transmission system electric power corresponding to the target output value from at least one of the power generator and the battery.

11. A device controlling a battery storing electric power generated by a power generator generating electric power using renewable energy, comprising:
a detector configured to acquire a power output data at plural points in time during a specific period, the power output data being the amount of electric power generated by the power generator; and
a controller configured to compute an average value of the power output data detected at the plural points so that different weights are applied to the power output data detected at the plural points in calculating the average value, to compute a target output value for supplying to an electric power transmission system based on the average value, to supply to the electric power transmission system electric power corresponding to the target output value from at least one of the power generator and the battery.
